(19) United States
(12) Patent Application Publication
(10) Pub. No.: US 2026/0281650 A1
(43) Pub. Date: Sep. 17, 2026

(54) Audio output system of 3D sound by selectively controlling sound source

(71) Applicant: Hyung Jun KIM, Goyang-si (KR)

(72) Inventor: Hyung Jun KIM, Goyang-si (KR)

(21) Appl. No.: 19/168,552

(22) PCT Filed: Dec. 20, 2023
(86) PCT No.: PCT/KR2023/021077

§ 371 Date: Sep. 24, 2025

(30) Foreign Application Priority Data
Jun. 1, 2023 (KR) 10-2023-0070928

(51) Int. Cl. H04S 7/00; G10K 15/08; H04S 5/00

(52) U.S. Cl. CPC H04S 7/302; G10K 15/08; H04S 5/005; H04S 2400/01; H04S 2400/05; H04S 2420/01

(57) ABSTRACT

The present invention discloses a technical idea comprising: a sound source extraction unit that filters out a video source from a predetermined terminal to which a sound source is applied together with a video source and selectively extracts only the sound source; a sound source processing unit that performs upmixing of the sound source extracted by the sound source extraction unit through a predetermined sound source processing, and processes the upmixed signal into a two-channel multi-dimensional sound signal through selective control; a sound source transmission unit that separately transmits the two-channel multi-dimensional sound signal processed by the sound source processing unit to the left and right speakers of the terminal.

### TECHNICAL FIELD

The present invention relates to a multi-dimensional 3D sound output system. More specifically, the invention pertains to a system that filters out mutual interference according to left and right signals through separation of sound sources from video sources and sound sources and multi-channel upmixing of the separated sound sources, and outputs multi-dimensional sound through selective control of left and right signals to a user's virtual location.

### BACKGROUND ART

According to global market research firm ReportLinker on May 11, 2023, the global audio equipment market is projected to reach $7.74 billion (approximately KRW 10.2438 trillion) this year. Considering last year's market size, which was estimated at $7.25 billion (approximately KRW 9.6 trillion), this represents a growth of approximately 6.76%.

According to related data, the speaker market, including home audio devices such as subwoofers and wall-mounted speakers, as well as TV soundbars, is expected to continue its growth.

In particular, the home audio market is evaluated to have shown remarkable growth. As the number of people enjoying content through TV at home increased during the COVID-19 pandemic, the number of people paying attention to audio equipment also increased, and ReportLinker explained that “users are increasingly aware of and demanding sound quality” and “are willing to spend more money on speakers.”

The US-based Digital Entertainment Group (DEG) also released a report stating that overall spending on “home entertainment,” including TVs and audio equipment, has increased. This suggests that, just as TV sales have significantly increased during the pandemic, the audio equipment market has also grown. ReportLinker stated, “With the growing popularity of home entertainment audio equipment, manufacturers such as Samsung, LG, Sony, and Bose are releasing products and platforms.” (See the May 16th article in Edaily.)

As related products become more sophisticated, that is, hardware performance increases and improves, software development and improvement are also rapidly progressing in line with existing hardware or hardware improvements and developments, and software technology development and improvement for various stereophonic sounds are also rapidly progressing.

Various technical ideas for processing and controlling acoustic signals have been patented and disclosed, and representative examples of these are as follows:

An “audio head-related transfer function (HRTF) interpolation method and an audio output device using the same (registration number 10-1899828, patent document 1)”.

According to patent document 1, it relates to a head-related transfer function (HRTF) interpolation method used for audio output and an audio output device using the same. The HRTF interpolation method receives HRTF data corresponding to a point where elevation and azimuth intersect. The method includes receiving ILD data for a point where HRTF data exists, and generating an HRTF interpolation signal corresponding to an elevation angle (φ) of a sound source localization point by using HRTF data corresponding to two points constituting the closest elevation angle segment from a sound source localization point (θ, φ). The method includes a step of calculating an ILD change amount from ILD data of two points constituting the azimuth line segment closest to a sound localization point (θ, φ) to an azimuth angle (θ) of the sound localization point, and a step of applying the ILD change amount to an HRTF interpolation signal corresponding to an elevation angle (φ) of the sound localization point, thereby generating a final HRTF interpolation signal corresponding to the sound localization point (θ, φ). According to an embodiment of the invention of Patent Document 1, the HRTF interpolation method enables a significant reduction in the amount of calculation, and thus has the advantage of being able to utilize interpolated HRTF values even when outputting real-time audio.

There is “personalized HRTF generation method (registration number 10-2274581, patent document 2)”.

Patent Document 2 discloses a method for generating a personalized HRTF. According to an embodiment of the invention, the method for generating a personalized HRTF includes a step of training an artificial intelligence model by labeling an HRTF on training ear images and training body information, and a step of inputting the user's ear images and body information into the trained artificial intelligence model to obtain a personalized HRTF.

There is “Partial HRTF compensation or prediction for ear-type microphone arrays (Publication No. 10-2022-0043171, Patent Document 3)”.

In some embodiments of patent document 3, an ear-mounted sound reproduction system is provided. The system includes an ear-mountable housing that rests within the auricle of the ear and obscures the ear canal. In some embodiments of patent document 3, the ear-mountable housing includes a plurality of outward-facing microphones. In the case of Patent Document 3, the outward-facing microphones may be positioned within the auricle of the ear rather than outside the ear canal, so the microphones will experience some, but not all, of the three-dimensional sound effects of the auricle. In the case of Patent Document 3, in some embodiments, sound is reproduced by an inwardly facing actuator element of the housing using a plurality of filters applied to signals received by a plurality of outwardly facing microphones, so as to preserve three-dimensional positioning cues that would be present at the eardrum in the absence of the housing, such that the housing is essentially transparent to the user. In the case of Patent Document 3, in some embodiments, techniques for deriving multiple filters are provided.

There is “A method and device for generating and processing parameters representing HRTFs (Registration No. 10-1333031, Patent Document 4)”.

According to Patent Document 4, a method for generating parameters representing HRTFs (Head-Related Transfer Functions) includes the steps of (a) sampling a first time-domain HRTF impulse response signal with a sample length (n) using a sampling rate (fs) that produces a first time-discrete signal, (b) converting the first time-discrete signal into a frequency domain that produces a first frequency-domain signal, (c) separating the first frequency-domain signals into sub-bands, and (d) generating first parameters of the sub-bands based on statistical measurements of the values of the sub-bands.

There is “A 3D audio signal processing device and method using a personalized head-related transfer function, and a high-realism multimedia playback system using the same (Registration No. 10-0954385, Patent Document 5) ”.

Patent Document 5 relates to a 3D audio signal processing device and method using a personalized head-related transfer function, and a high-presence multimedia playback system using the same, which generates a 3D audio signal using a head-related transfer function modeled to fit the physical characteristics of each user, thereby providing a 3D audio signal with the greatest sense of presence and reality to each user.

The invention of Patent Document 5 includes a 3D audio signal processing device using a head-related transfer function, an audio decoding means for decoding audio data to restore an original audio signal; and a 3D audio generating means for generating a 3D audio signal for the restored audio signal using a head-related transfer function modeled to fit the user's body characteristics.

(Patent Document 1) Korean Patent Registration No. 10-1899828

(Patent Document 2) Korean Patent Registration No. 10-2274581

(Patent Document 3) Korean Patent Publication No. 10-2022-0043171

(Patent Document 4) Korean Patent Registration No. 10-1333031

(Patent Document 5) Korean Patent Registration No. 10-0954385

### DISCLOSURE

### Technical Problem

According to the present invention, the audio output system of 3D sound by selectively controlling sound source was devised to address the limitations of conventional technologies. The invention aims to solve the following problems:

First, it is to provide the multi-dimensional sound effect of a two-channel stereo input signal.

Second, it is to allow the effect on the user's left and right pitch to be doubled.

Third, it is to enable the user to control the mid to adjust the distance of the ghost image.

The problems to be solved by the present invention are not limited to those mentioned above, and other problems not mentioned can be clearly understood by those skilled in the art from the description below.

### Technical Solution

The audio output system of 3D sound by selectively controlling sound source according to the present invention has the following problem-solving means to solve the above-mentioned problem.

The system relates to a audio output system of 3D sound by selectively controlling sound source. The system comprises a sound source extraction unit that filters out a video source from a predetermined terminal to which a sound source is applied together with a video source and selectively extracts only the sound source; a sound source processing unit that performs upmixing of the sound source extracted by the sound source extraction unit through a predetermined sound source processing, and processes the upmixed signal into a two-channel multi-dimensional sound signal through selective control; a sound source transmission unit that separately transmits the two-channel multi-dimensional sound signal processed by the sound source processing unit to the left and right speakers of the terminal.

The system comprises the sound source characterized by being a two-channel stereo type sound source.

The sound source processing unit includes an upmixer that upmixes the sound source into a multi-channel multi-sound source by passing the sound source through a predetermined upmix filter.

The multi-channel system is characterized by setting the multi-sound source to 5.1 channels or more, and allocating the 5.1 channels to a front center channel, a front right channel, a front left channel, a rear right channel, a rear left channel, and a woofer channel, based on a preset position of a user virtually positioned in front of a predetermined terminal of the multi-sound source.

The sound source unit further includes a cross noise canceler that, based on a preset position of a user virtually positioned in front of a predetermined terminal, i) removes a remaining front left channel component from a front right channel and removes a remaining front right channel component from a front left channel, and ii) removes a remaining rear left channel component from a rear right channel and removes a remaining rear right channel component from a rear left channel.

The sound source processing unit further includes a sound pressure setter that selectively adjusts the sound pressure of the front left channel and the rear left channel relative to the front right channel and the rear right channel, in order to localize the virtual position of a ghost image of an object on the terminal based on a preset position of a user virtually positioned in front of a predetermined terminal of the multi-sound source.

The sound source processing unit further comprises a time difference setter that selectively adjusts a predetermined sound time difference between the front left channel and the rear left channel compared to the front right channel and the rear right channel, in order to localize the virtual position of a ghost image of an object on the terminal based on a preset position of a user virtually positioned in front of a predetermined terminal of the multi-sound source.

The sound source processing unit further includes a distance setter that selectively adjusts the variability in sound volume over time of the front left channel and the rear left channel relative to the front right channel and the rear right channel, based on a preset position of a user virtually positioned in front of a predetermined terminal of the multi-sound source.

The sound source processing unit further includes a reverberation setter that repeatedly adds the reverberation signals of the front left channel and the rear left channel to the front right channel and the rear right channel according to a reverberation time difference setting value, based on a preset position of a user virtually positioned in front of a predetermined terminal of the multi-sound source.

The sound source transmission unit is characterized in that the front right channel and the rear right channel are allocated to the right speaker section of the predetermined terminal, the front left channel and the rear left channel are allocated to the left speaker section, and the front channel and the woofer channel are selectively allocated and transmitted to the left speaker section and the right speaker section.

### Advantageous Effects

The audio output system of 3D sound by selectively controlling sound source, according to the present invention, has the following advantages:

First, it is possible to upmix two-channels into multi-channels and process a sound source to produce a multi-dimensional sound effect similar to multi-channels even in stereo type by eliminating left and right mutual signal interference for the input sound source.

Second, the sound source for the left and right speakers is reprocessed to double the effect on the left and right sound quality by eliminating any mutual interference signals that may occur from the left and right speakers.

Third, the sound source for the left and right speakers is reprocessed so that the user can feel the distance control of the ghost image through mid-adjustment of the ghost image.

The effects mentioned above are not exhaustive, and further advantages will be apparent to those skilled in the art from the detailed description that follows.

### DESCRIPTION OF DRAWINGS

FIG. 1 is a conceptual diagram of one embodiment of the present invention.

FIG. 2 is a block diagram illustrating the main configuration of the system according to one embodiment of the present invention.

FIG. 3 is a block diagram illustrating a sound source processing unit and its sub-components of the system according to one embodiment of the present invention.

FIG. 4 is a conceptual diagram of an upmixer of the system according to one embodiment of the present invention.

FIG. 5 is a conceptual diagram illustrating the processing of ghost images and the concept of the system according to one embodiment of the present invention.

FIG. 6 is a conceptual diagram of a cross-noise canceler of the system according to one embodiment of the present invention.

FIG. 7 is a conceptual diagram of a sound pressure setter for left and right speakers of the system according to one embodiment of the present invention.

FIG. 8 is a conceptual diagram of a time difference setter for left and right speakers of the system according to one embodiment of the present invention.

FIG. 9 is a conceptual diagram of a distance setter of the system according to one embodiment of the present invention.

FIG. 10 is a conceptual diagram of a reverberation setter of the system according to one embodiment of the present invention.

FIG. 11 is a conceptual diagram illustrating the process of representing the sound wave arrival time difference information file between the two ears as a bit array and then bundling it into a set of individual bundles according to one embodiment of the present invention.

FIG. 12 is a conceptual diagram illustrating reordering of items grouped into sets using a preset reordering function according to one embodiment of the present invention.

### MODE FOR INVENTION

According to an embodiment of the present invention, the system can undergo various modifications and be implemented in multiple embodiments. Specific embodiments are illustrated in the accompanying drawings and described in detail below. However, these embodiments are not intended to limit the invention to the particular forms disclosed, but rather to cover all modifications, equivalents, and alternatives falling within the scope of the invention.

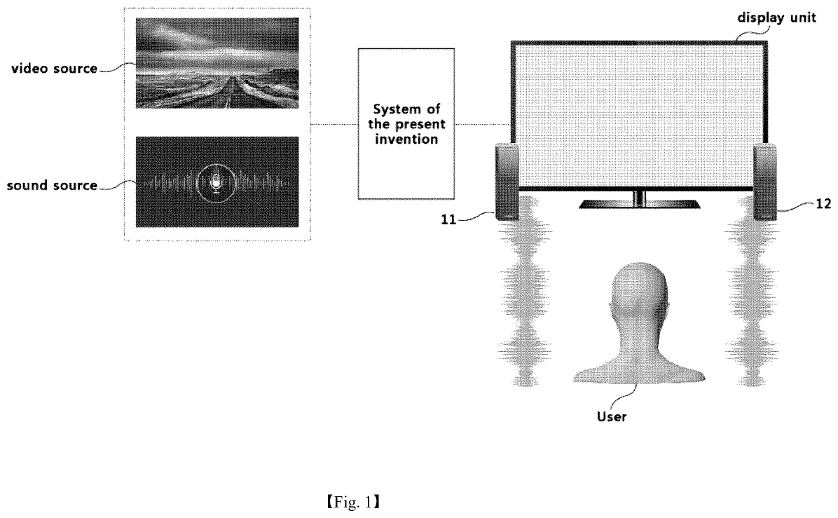

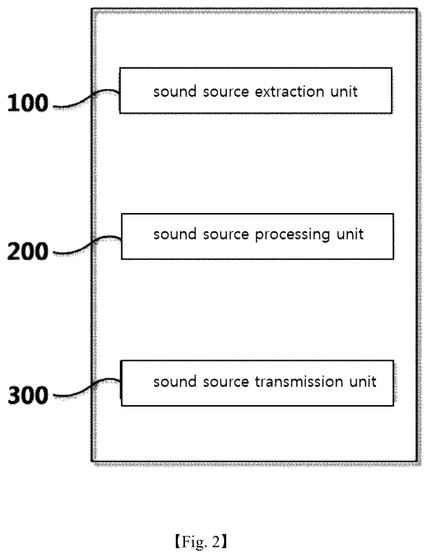

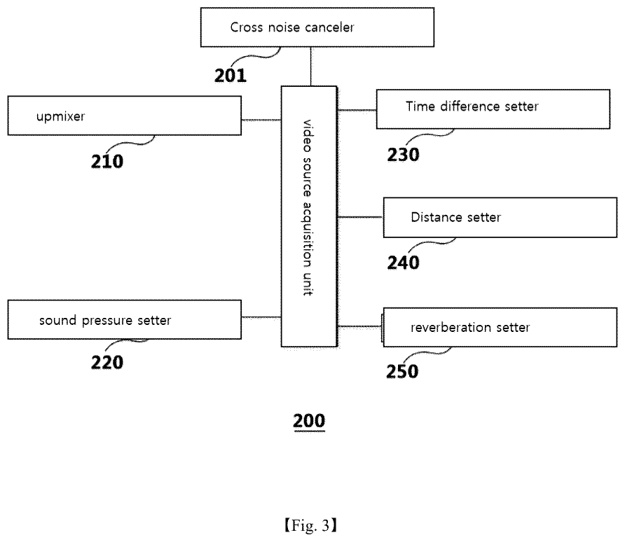

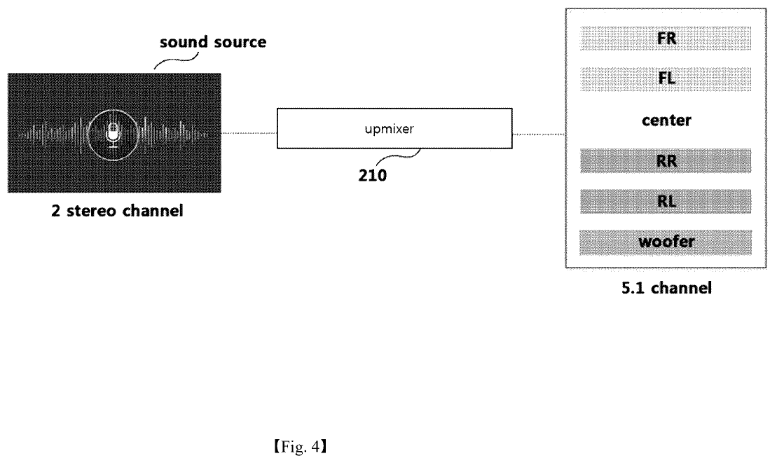

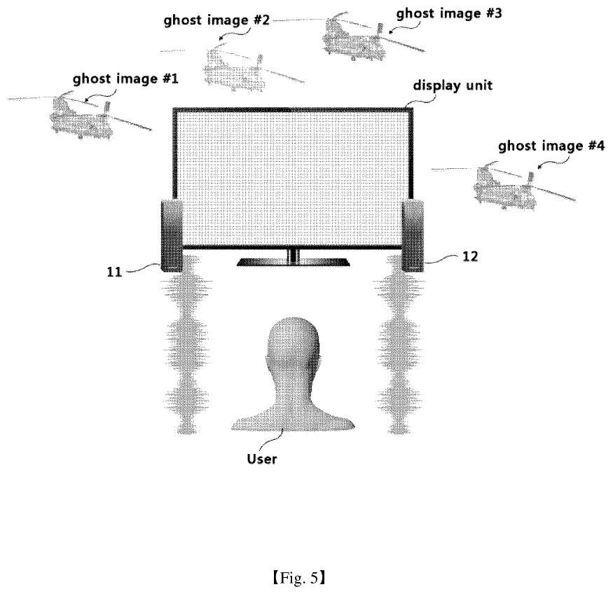

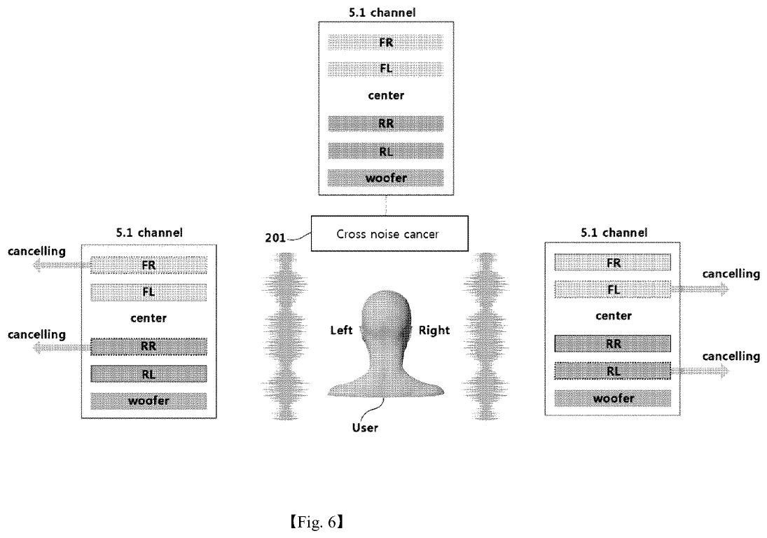

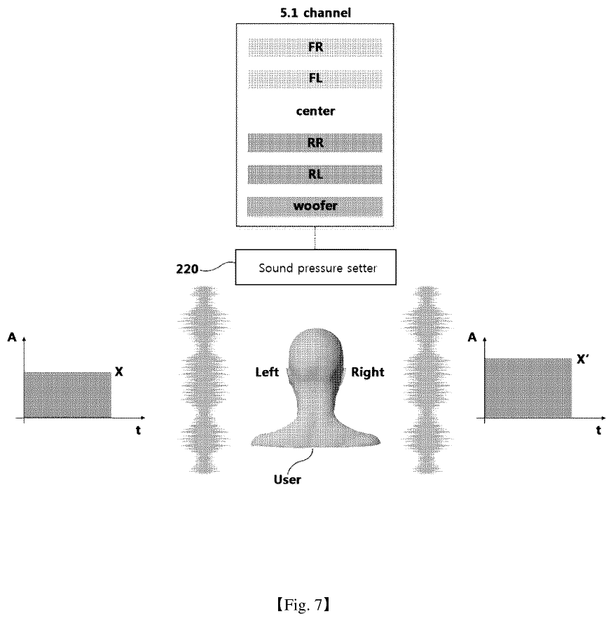

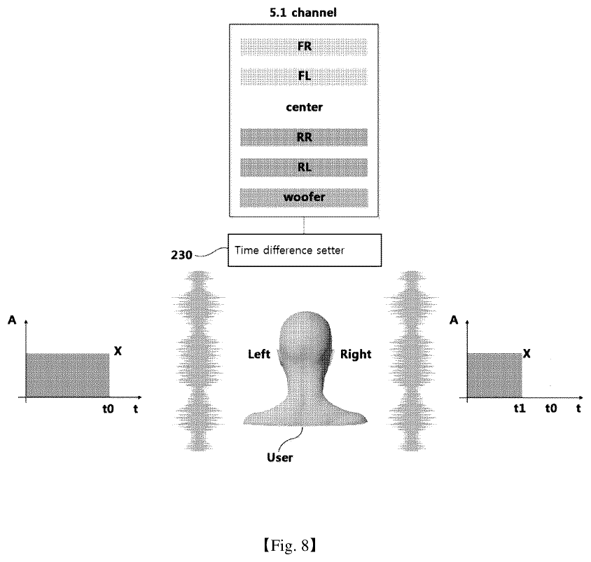

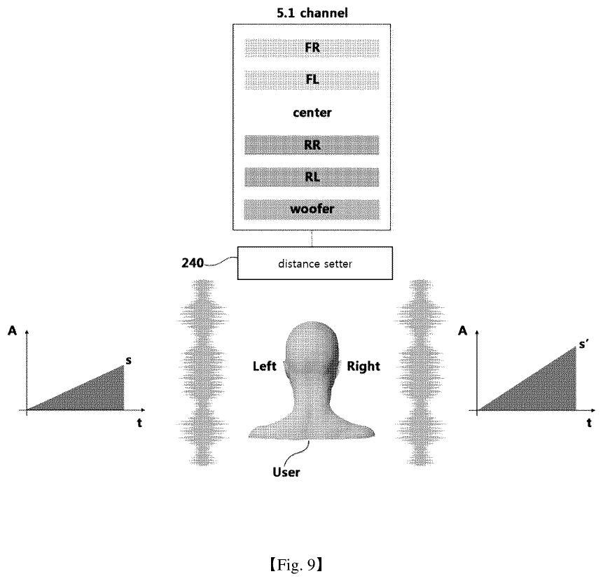

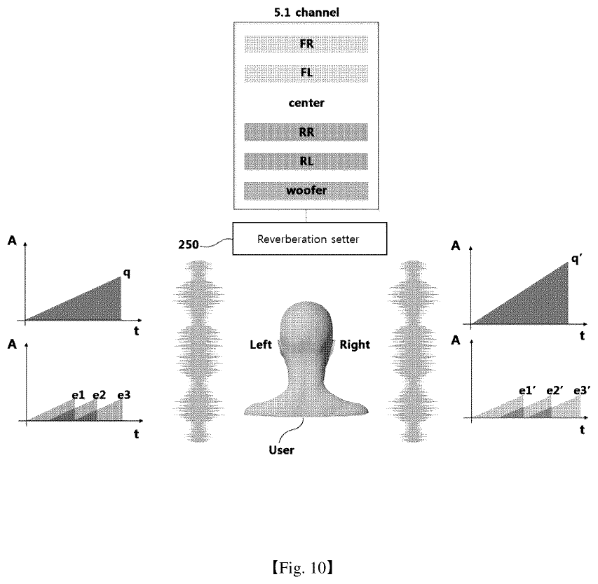

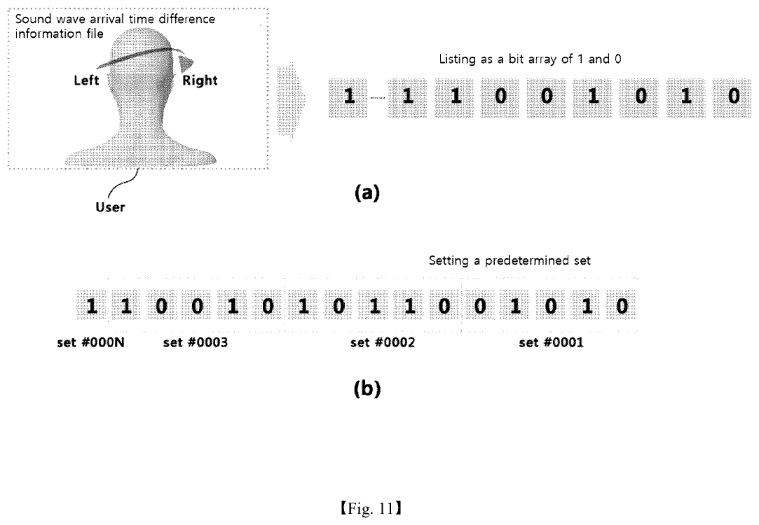

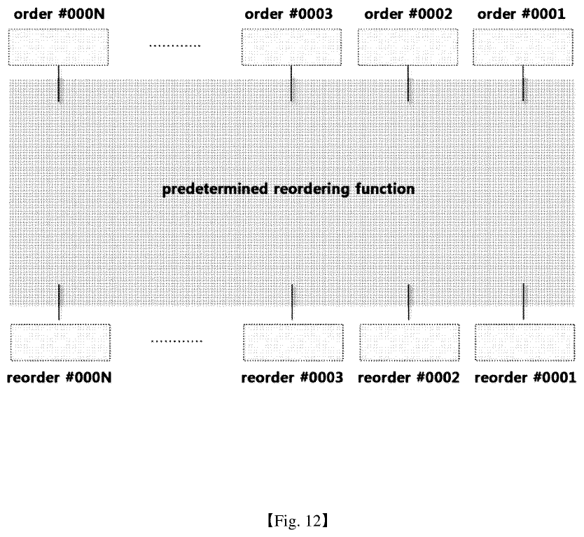

FIG. 1 is a conceptual diagram of one embodiment of the present invention. FIG. 2 is a block diagram illustrating the main configuration of the system according to one embodiment of the present invention. FIG. 3 is a block diagram illustrating a sound source processing unit and its sub-components of the system according to one embodiment of the present invention. FIG. 4 is a conceptual diagram of an upmixer of the system according to one embodiment of the present invention. FIG. 5 is a conceptual diagram illustrating the processing of ghost images and the concept of the system according to one embodiment of the present invention. FIG. 6 is a conceptual diagram of a cross-noise canceler of the system according to one embodiment of the present invention. FIG. 7 is a conceptual diagram of a sound pressure setter for left and right speakers of the system according to one embodiment of the present invention. FIG. 8 is a conceptual diagram of a time difference setter for left and right speakers of the system according to one embodiment of the present invention. FIG. 9 is a conceptual diagram of a distance setter of the system according to one embodiment of the present invention. FIG. 10 is a conceptual diagram of a reverberation setter of the system according to one embodiment of the present invention. FIG. 11 is a conceptual diagram illustrating the process of representing the sound wave arrival time difference information file between the two ears as a bit array and then bundling it into a set of individual bundles according to one embodiment of the present invention. FIG. 12 is a conceptual diagram illustrating reordering of items grouped into sets using a preset reordering function according to one embodiment of the present invention.

The terms “unit” and “module” as used in this patent specification should be understood as a component defined as a functional unit implemented through a program or software.

As shown in FIG. 1, this present invention corresponds to a system of processing a sound source from a video source or sound source approved by a display unit to generate multi-dimensional sound through the speaker of the display unit. In the case of the above method, the program is activated simply by mounting it on the HDMI of the display unit, allowing the 3D sound processing to be turned ON or OFF.

First, the present invention is to produce a multi-dimensional sound effect from a sound source applied as a two-channel stereo type, and at the same time, to produce a multi-dimensional sound effect in a state where the physical speakers (collectively referred to as 11 and 12) of the display unit are equipped with two speakers, for example, a left speaker (11) and a right speaker (12).

To this end, as shown in FIGS. 1 and 2, the present invention may include a sound source extraction unit (100), a sound source processing unit (200), and a sound source transmission unit (300).

First, the sound source extraction unit (100) corresponds to a configuration that filters out the video source from a predetermined terminal, such as a display unit, to which a sound source is applied together with a video source, and selectively extracts only the sound source.

In the case of separate extraction of only the sound source from the video/audio source, this corresponds to a typical technical configuration and therefore a separate explanation will be omitted.

As shown in FIGS. 1 and 2, the sound source processing unit (200) is configured to upmix the sound source extracted separately by the sound source extraction unit (100) through a predetermined sound source processing, and to process the upmixed signal into a two-channel surround sound signal through selective control.

The detailed technical features for a given sound source processing correspond to the functions illustrated in FIGS. 3 to 9, etc., and will be described together with the description of the detailed configuration.

The sound source processing unit (200) corresponds to a technical configuration that upmixes a two-channel stereo type sound source, then separates and extracts the channels into multiple channels such as 5.1 channels, then selectively controls each channel, and then downmixes it back into two-channels to produce a multi-dimensional sound effect through the two physical speakers (11, 12) of the display unit.

As shown in FIG. 1, the sound source transmission unit (300) corresponds to a technical configuration that transmits sound to two physical speakers (11, 12) using sound sources that have been upmixed and processed by the sound source processing unit (200) and then re-downmixed.

As shown in FIG. 4, the sound source processing unit (200) may include an upmixer (210).

The upmixer (210) is configured to up mix a sound source into a multi-channel multi-sound source by passing the sound source through a predetermined up mix filter.

The upmixer (210) sets the multi-sound source to 5.1 channels or more, and is configured to allocate the 5.1 channels to a front center channel, a front right channel, a front left channel, a rear right channel, a rear left channel, and a woofer channel, respectively, based on a preset position of a user virtually placed in front of a given terminal.

As illustrated in FIG. 1, the preset position may be set to a virtual position where the user is tentatively expected to be positioned in front of the display unit.

Assuming that the center of the display placed in the front actually has a front center speaker, front light speaker, front left speaker, rear light speaker, rear left speaker, and woofer channel speaker, centering on a user in a preset position, the 5.1 multi-channel to be assigned to each of these is upmixed by channel-separating the front center channel, the front right channel, the front left channel, the rear right channel, the rear left channel, and the woofer channel.

In the future, these multi-channel signals upmixed from a two-channel stereo type sound source by the upmixer (210) will be able to undergo various subsequent processing steps after going through a control procedure according to the cross-noise canceler (201).

As described above, the sound source processing unit (200) may further include a cross noise canceler (201).

As shown in FIG. 6, the cross-noise canceler (201) corresponds to a configuration that filters out mutual interference/noise between sound sources input from the left ear and the right ear at a virtual preset position of the user, for example, a space several meters away from the center in front of the display unit.

Each of the front center channel, front right channel, front left channel, rear right channel, rear left channel, and woofer channel, which are each separated into 5.1 multiple channels, has a filter for the left channel and a filter for the right channel, respectively. Each of these channels passes these signals separated into 5.1 channels, through the left channel filter and the right channel filter, respectively, to remove any left channel components that may remain as interference or noise in the front right channel and rear right channel, and conversely, to remove any right channel components that may remain as interference or noise in the front left channel and rear left channel.

As shown in FIGS. 5 and 7, the sound source processing unit (200) may further include a sound pressure setter (220).

The sound pressure setter (220) is configured to set the sound pressure of the left and right ears differently for each channel according to the position setting of the ghost image of the assumed object on the screen, based on the user's preset position, and the standard for recognizing the sense of position/spatial space of the ghost images (#1-#4) in FIG. 5 can be recognized through the difference in pressure of the left and right ears.

As illustrated in FIG. 7, the sound pressure setter (220) selectively adjusts the sound pressure of the front left channel and the rear left channel in comparison with the front right channel and the rear right channel, in order to localize the virtual position of the ghost image of the object on the display unit based on the preset position of the user who is virtually placed in front of a predetermined terminal, for example, the display unit, using the multi-sound source.

In FIG. 5, the ghost image (#1) can provide the user with a sense of space in terms of the left and right positions of the ghost image (#1) by creating a difference in sound pressure between the left and right ears in FIG. 7. For channels going to the left speaker, for example, FL and RL, the sound pressure, that is, the amplitude of the sound source, is set to be large for the same time, and depending on the degree of leftward shifting of the ghost image (#1), the sound pressure, that is, the amplitude of the sound source, of FR and RR going to the right channel is set to be relatively small for the same time compared to the channel going to the left speaker, so that the degree of leftward shifting of the image of the object on the screen can be provided to the user by adjusting the difference in sound pressure between the left and right sound sources.

Conversely, in order to give the user a sense of space by being tilted to the right, as in the ghost image (#4) in FIG. 5, the sound pressure, i.e., the amplitude of the sound source, is made smaller for the channels going to the left speaker, for example, FL and RL, and depending on the degree of right tilting of the ghost image (#4), the sound pressure, i.e., the amplitude of the sound source, of the FR and RR going to the right channel is made relatively larger for the same time compared to the channel going to the left speaker. However, the setting of the left-right spatial sense through this difference in sound pressure is advantageous in the high-frequency region where the wavelength of sound waves is smaller than the size of the user's virtual head circumference.

As shown in FIGS. 5 and 8, the sound source processing unit (200) may further include a time difference setter (230).

The time difference setter (230) can also set the left and right spatial sense of the ghost image (#1-#4) and transmit the spatial sense according to the time difference of the sound source transmitted to the left and right ears.

As illustrated in FIG. 8, the time difference setter (230) is configured to selectively adjust a predetermined sound time difference of the front left channel and the rear left channel relative to the front right channel and the rear right channel in order to localize a virtual position of a ghost image of an object on a predetermined terminal based on a preset position of a user virtually positioned in front of a predetermined terminal, using a multi-sound source. In the case of providing a sense of space to the left and right ears through setting the time difference, there is an advantage that it can be possible even in the low-frequency range where the wavelength of the sound wave is larger than the user's virtual head diameter, but there is also a possibility that mixing and interference with other sounds may occur depending on the time difference, that is, the degree of time delay of the sound signal. The position and spatial sense of ghost images (#1-#4) can be set and transmitted by selectively applying the sound pressure setter (220) and the time difference setter (230).

Based on the given information about the diameter of the user's head, the speed of sound wave transmission and, accordingly, the difference between the speed of sound wave transmission and the delay time corresponding to the length of the user's head diameter are calculated and used as a given value for setting the time difference of the time difference setter (230). The user's head diameter can be set differently depending on age, gender, or artificial differences, and a statistical standard can be applied, but here, it is set as a variable (function) for the head diameter, and a constant value for the head diameter variable, that is, the actual user's head diameter information, can be input so that calculations such as time differences can be produced differently.

In the case of head diameter, there are cases where time difference information produced according to head diameter may occur even if the head diameter is the same. This means that in the case of sound transmitted through the two ears, that is, the right and left ears, a time difference in sound wave transmission between the two ears may occur depending on the multi-dimensional sound effect of the user's front face centered on the two ears, and this part is calculated based on statistical information about the three-dimensional shape of the user's face. The user's facial information is made possible through a user facial recognizer(not shown) user face recognizer, which can introduce functions by linking with an app such as a smartphone equipped with a 3D recognition function for user facial recognition and the system according to the present invention.

In the case of information files about the time difference of sound waves between the two ears according to the user face recognizer and the user's facial 3D recognition, they can be divided into multiple sub-files, and the files divided into sub-files are given the same parameter code and then stored separately in multiple physically divided DBs to prevent arbitrary hacking by third parties. Third parties cannot re-merge without information about the intermediate code that mediates the sub-files in the event of arbitrary hacking, making arbitrary hacking difficult.

As shown in FIG. 11, in the case of the information file about the time difference of sound waves between the two ears, the user face recognizer lists them as a bit array of 1 and 0. Afterwards, by setting a predetermined set, the bit array of 1 and 0 is redefined as a new bundle unit, i.e., a set of sets and a set array, as shown in FIG. 11(b).

As shown in FIG. 11, the predetermined set defines five bits of 1 and 0, which may vary depending on what is being determined.

As shown in FIG. 12, the face recognizer sequentially inputs the sets of FIG. 11 into the sets of order #0001, order #0002, and order #000N. If you input order #0001, order #0002, and order #000N into the predetermined reordering function, they will be reordered sequentially as reorder #0001, reorder #0002, and reorder #000N according to the predetermined reordering function rules of the predetermined reordering function, which has a rule for transforming the information file about the time difference of sound waves between the two ears, which is the information of the first bit array, according to the purpose. This prevents the information file about the time difference between the sound waves between the two ears from being known to the outside, even in the event of external access or hacking by a third party.

As shown in FIGS. 5 and 9, the sound source processing unit (200) may further include a distance setter (240).

The distance setter (240) provides the effect of moving away from or closer to the user's preset position, and also provides a function that can simultaneously provide a sense of placement to the left or right.

The distance setter (240) is configured to selectively adjust the variability of the sound size of the front left channel and the rear left channel over time compared to the front right channel and the rear right channel, based on the preset position of the user who is virtually positioned in front of a predetermined terminal, such as a display unit, with the multi-sound source.

In FIG. 5, a ghost image (#3) placed far from the user and a ghost image (#4) placed relatively close to the user can be set to approach the user from the left to the right. In this case, in FIG. 9, the control of the sound source is performed in the direction of increasing amplitude, that is, the size of the sound pressure, in the upward right direction over time for both the left channel going to the left speaker and the right channel going to the right speaker, and at the same time, the size of the channel going to the left speaker, that is, the slope, and the size of the channel going to the right speaker are set differently, that is, the slope of the signal of the channel going to the right speaker is set larger, so that the left->right movement of the ghost image and the sense of space approaching the user can be provided.

As shown in FIGS. 5 and 9, the sound source processing unit (200) may further include a reverberation setter (250).

The reverberation setter (250) is configured to repeatedly add reverberation signals of the front left channel and rear left channel to the front right channel and rear right channel according to a reverberation time difference setting value based on a preset position of a user virtually placed in front of a predetermined terminal, for example, a display unit, of a multi-Sound source.

Another important factor in the perception of distance is the reverberation effect.

Reverberation refers to the effect of a sound remaining and being heard even after the sound has stopped resonating in a room. As the distance from the ghost image of the sound source to the user increases, the amplitude, or size of the sound decreases inversely proportional to the square of the distance. On the other hand, since the amplitude of the reverberation does not originate from the sound source but from things adjacent to the user's position, the ratio of the amplitude of the reverberation to the direct sound is greater for objects that are close than for objects that are far away. Therefore, the reverberation effect of a distant object is relatively greater than that of a nearby object.

As illustrated in FIG. 2, the sound source transmission unit (300) transmits the front right channel and the rear right channel by assigning them to the right speaker section of a given terminal, for example, a display unit, the front left channel and the rear left channel by assigning them to the left speaker section, and the front channel and the woofer channel by selectively assigning them to the left speaker section and the right speaker section.

The scope of the present invention is determined by the matters described in the patent claims, and the parentheses used in the patent claims are not written for optional limitation, but are used to indicate clear components, and the description within the parentheses should also be interpreted as essential components.

1. A system for providing multi-dimensional sound output through selective control of sound sources, the system comprising:
A sound source extraction unit that filters out a video source from a predetermined terminal to which a sound source is applied together with a video source and selectively extracts only the sound source;
A sound source processing unit that performs upmixing of the sound source extracted by the sound source extraction unit through a predetermined sound source processing, and processes the upmixed signal into a two-channel multi-dimensional sound signal through selective control;
A sound source transmission unit that separately transmits the two-channel multi-dimensional sound signal processed by the sound source processing unit to the left and right speakers of the terminal.

2. The system of claim 1, wherein the sound source is characterized by being a two-channel stereo type sound source.

3. The system of claim 2, wherein the sound source processing unit is characterized by including an upmixer that upmixes the sound source into a multi-channel multi-sound source by passing the sound source through a predetermined upmix filter.

4. The system of claim 3, wherein the multi-channel system is characterized by setting the multi-sound source to 5.1 channels or more, and allocating the 5.1 channels to a front center channel, a front right channel, a front left channel, a rear right channel, a rear left channel, and a woofer channel, based on a preset position of a user virtually positioned in front of a predetermined terminal of the multi-sound source.

5. The system of claim 4, wherein the sound source unit further includes a cross noise canceler that, based on a preset position of a user virtually positioned in front of a predetermined terminal,
i) removes a remaining front left channel component from a front right channel and removes a remaining front right channel component from a front left channel, and
ii) removes a remaining rear left channel component from a rear right channel and removes a remaining rear right channel component from a rear left channel.

6. The system of claim 5, wherein the sound source processing unit further includes a sound pressure setter that selectively adjusts the sound pressure of the front left channel and the rear left channel relative to the front right channel and the rear right channel, in order to localize the virtual position of a ghost image of an object on the terminal based on a preset position of a user virtually positioned in front of a predetermined terminal of the multi-sound source.

7. The system of claim 5, wherein the sound source processing unit further comprises a time difference setter that selectively adjusts a predetermined sound time difference between the front left channel and the rear left channel compared to the front right channel and the rear right channel, in order to localize the virtual position of a ghost image of an object on the terminal based on a preset position of a user virtually positioned in front of a predetermined terminal of the multi-sound source.

8. The system of claim 5, wherein the sound source processing unit further includes a distance setter that selectively adjusts the variability in sound volume over time of the front left channel and the rear left channel relative to the front right channel and the rear right channel, based on a preset position of a user virtually positioned in front of a predetermined terminal of the multi-sound source.

9. The system of claim 8, wherein the sound source processing unit further includes a reverberation setter that repeatedly adds the reverberation signals of the front left channel and the rear left channel to the front right channel and the rear right channel according to a reverberation time difference setting value, based on a preset position of a user virtually positioned in front of a predetermined terminal of the multi-sound source.

10. The system of any one of claims 6 and 9, wherein the sound source transmission unit is characterized in that the front right channel and the rear right channel are allocated to the right speaker section of the predetermined terminal, the front left channel and the rear left channel are allocated to the left speaker section, and the front channel and the woofer channel are selectively allocated and transmitted to the left speaker section and the right speaker section.
